(19) United States
(12) Patent Application Publication
(10) Pub. No.: US 2015/0294005 A1
(43) Pub. Date: Oct. 15, 2015

(54) METHOD AND DEVICE FOR ACQUIRING INFORMATION

(71) Applicant: TENCENT TECHNOLOGY (SHENZHEN) COMPANY LIMITED, Shenzhen Guangdong (CN)

(72) Inventors: Yi Hu, Shenzhen Guangdong (CN); Lei Liu, Shenzhen Guangdong (CN); Yao Zhao, Shenzhen Guangdong (CN); Jia Cheng, Shenzhen Guangdong (CN)

(73) Assignee: TENCENT TECHNOLOGY (SHENZHEN) COMPANY LIMITED, Shenzhen Guangdong (CN)

(21) Appl. No.: 14/750,980

(22) Filed: Jun. 25, 2015

Related U.S. Application Data
(63) Continuation of application No. PCT/CN2013/088920, filed on Dec. 10, 2013.

(30) Foreign Application Priority Data
Dec. 27, 2012 (CN) 201210579273.7

(51) Int. Cl. G06F 17/30; G06Q 40/00

(52) U.S. Cl. CPC G06F 17/30864; G06F 17/30887; G06Q 40/12

(57) ABSTRACT

A method and an apparatus for acquiring information are provided. An example method includes acquiring a search word on a web page; acquiring a first web page set related to the search word and a template related to the search word when a content value-added service on the web page is triggered. The method may further include performing screening of the first web page set to obtain a selected web page satisfying a screening condition. The method further includes mining the selected web page for corresponding key information according to the template and outputting the corresponding key information. Thus, a search engine actively searches for and mines key information from massive data of web pages available on the Internet according to a preset template to improve service quality and efficiency of the search engine without relying on external data.

This application is a continuation of PCT/CN2013/088920, filed on Dec. 10, 2013 and entitled “METHOD AND APPARATUS FOR ACQUIRING INFORMATION,” which claims priority to Chinese Patent Application No. 201210579273.7, entitled “METHOD AND APPARATUS FOR ACQUIRING INFORMATION” filed on Dec. 27, 2012, both of which are incorporated herein by reference in their entirety.

### FIELD OF THE TECHNOLOGY

The present document generally relates to the field of communication technologies, and in particular, to acquiring information.

### BACKGROUND OF THE DISCLOSURE

The Internet facilitates a user to access a large number of websites. The user may search the websites for information. A website may vie for a visit from the user and therefore face a technical problem to provide the user with search results that can match the information that the user seeks.

Generally, a universal open platform is provided, and interfaces of the platform are opened to owners of specific information data, for example, owners of data such as weather information, stock information, and map information. After search words that are entered by the user are acquired, if the search is conducted by a specific user, apart from providing general search results, a search engine may further output specific information by using the interfaces of the universal open platform. The search engine may, thus, match the specific user with the specific information.

In this case, the search engine searches data that is externally provided to the search engine. The externally provided data may be limited to data such as weather data, stock data, or microblog data. The search engine can only passively receive the data that is provided externally. Thus, the search engine may face a technical problem that it cannot use data that may be available from the websites across the Internet to provide search results for the user, and hence may not meet the user's needs.

### SUMMARY

In order to improve search quality, the present document provides technical solutions to the above technical problem. Examples of the technical solutions such as a method and an apparatus for acquiring information are described throughout the present document.

One general aspect includes a method for acquiring information, including receiving a search word via a web page. The method also includes identifying a first web page set corresponding to the search word in response to a value-added service on the web page being triggered. The method also includes screening the first web page set to select a selected web page that satisfies a screening condition. The method also includes mining the selected web page for key information according to fields of a template corresponding to the search word. The method also includes outputting the key information.

Another general aspect includes an apparatus for acquiring information, the apparatus including one or more processors. The apparatus also includes memory; and a plurality of program units stored in the memory and to be executed by the one or more processors. The program units include an access unit configured to acquire a search word on a web page. The program units also include an acquiring unit configured to acquire a first web page set corresponding to the search word and a template corresponding to the search word in response to a value-added content service on the web page being triggered. The program units also include a screening unit configured to select a selected web page from the first web page set. The program units also include a mining unit configured to mine the selected web page for key information corresponding to the template. The apparatus also includes an output unit configured to output the key information using predetermined fields of the template.

Another general aspect includes a computer readable storage medium storing computer executable instructions, the computer readable storage medium including instructions to acquire a search word on a web page. The computer readable storage medium also includes instructions to identify a first web page set corresponding to the search word and identify a template related to the search word in response to a value-added service on the web page being triggered. The computer readable storage medium also includes instructions to select a selected web page based on a screening condition. The computer readable storage medium also includes instructions to identify, in the selected web page, key information corresponding to fields of the template. The computer readable storage medium also includes outputting the key information according to the fields of the template.

The technical solutions provided in the present document do not rely on external data for providing search results. A search engine may actively search for data of a website available through the Internet, and may mine for key information from data from multiple websites according to preset template information. The technical solutions may improve service quality and efficiency of the search engine and hence thereby satisfying the user's search needs.

### BRIEF DESCRIPTION OF THE DRAWINGS

The examples may be better understood with reference to the following drawings and description. The components in the figures are not necessarily to scale. Moreover, in the figures, like-referenced numerals designate corresponding parts throughout the different views.

FIG. 1 is a flowchart of an example method for acquiring information;

FIG. 2 is a flowchart of an example method for acquiring information;

FIG. 3A is a schematic structural diagram of an example apparatus for acquiring information;

FIG. 3B is a schematic structural diagram of units in an example apparatus for acquiring information;

FIG. 4 is a schematic structural diagram of another example apparatus for acquiring information; and

FIG. 5 is a schematic structural diagram of another example apparatus for acquiring information.

### DESCRIPTION OF EMBODIMENTS

A content value-added service of a search engine may include constituent components of the search engine such as a web crawler, a web page information indexing, a search word retrieval, and artificial intelligence components, such as circuitry performing data mining and natural language processing.

The web crawler of the search engine is a program or script that automatically crawls Internet web pages according to certain rules. The web crawler may select a seed uniform/universal resource locators (URLs), and put the URLs into a to-be-crawled URL queue. The web crawler may take out URLs to be crawled from the to-be-crawled URL queue, perform a domain name system (DNS) resolution to obtain corresponding Internet Protocol addresses (IPs). The web crawler may download web pages corresponding to the IPs to a downloaded-web-page library. The URLs of the respective downloaded web pages may be added into a crawled URL queue. AURL embedded in the respective downloaded web pages may be extracted, and the extracted URLs may be added into the to-be-crawled URL queue. During a next crawling cycle, the to-be-crawled URL queue may be used again. The crawling cycles may continue until certain stop conditions are met. The crawler may accumulate a large amount of web page data for the search engine by means of such a cyclical crawling process.

The search engine may establish an index for the web pages that have been crawled by the web crawler. The index may be referred to as a web page information index. For example, the search engine may store collected web pages, and compress and arrange the collected web pages according to a certain format to form a data structure of inverted indexes. In this way, the search engine may provide quick responses to retrieval behaviors regarding a search word.

The search engine may retrieve information from the inverted index in response to receiving a search word from a user. As a result of the web pages being arranged according to a predetermined structure in advance, the search engine may find web pages corresponding to the search word from the user in shorter time than without structuring the web pages. In the web pages that initially hit the search word of the user, correlation degrees between the web pages and the search word may be determined. The web pages may be sorted according to the correlation degrees. The web pages may be output to be viewed by the user.

The data mining is a process of extracting information and knowledge hidden in a massive, noisy, and fuzzy application data. The found knowledge may be used for information management, decision support, process control, or the like. The data mining may improve applications of search engine data from a low-level simple search to mining knowledge from data.

The natural language processing is a process of understanding and generating natural language statements by using a computer. For example, information in web pages may be in a particular natural language, such as Chinese, English, or French texts. From the perspective of linguistics, the texts may be interpreted as: characters form a word; words form a phrase; phrases for a sentence; and sentences further form a paragraph, a section, a chapter, and an article. There may be ambiguity and polysemy phenomena in the foregoing various levels. In order to resolve ambiguity, a large amount of background knowledge and reasoning may be used, which may be included in the process of processing natural languages.

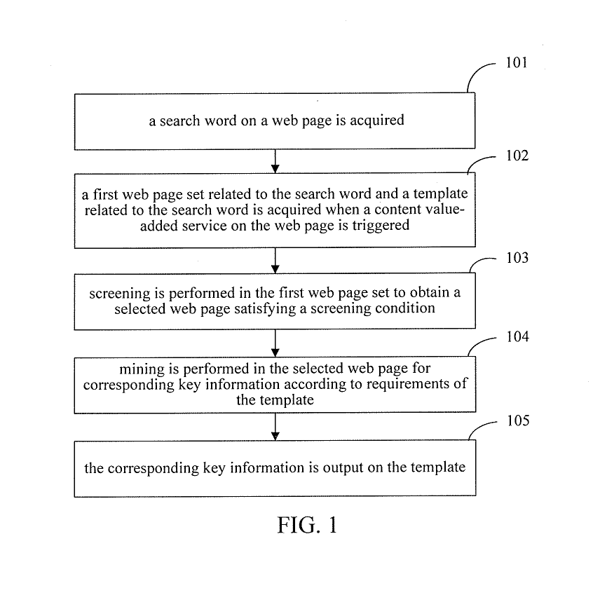

Referring to FIG. 1, an example method for acquiring information may include at least the following steps. In Step 101, a search word on a web page may be acquired or received by a search engine. In Step 102, the search engine may identify a first web page set related to the search word. The search engine may additionally identify a template related to the search word. The search engine may identify the above, for example when a content value-added service on the web page is triggered. In Step 103, the search engine may screen the first web page set to obtain a selected web page satisfying a screening condition. In Step 104, the search engine may mine the selected web page for corresponding key information based on the template. In Step 105, the corresponding key information may be output on the template.

Thus, the search engine may not rely on external data to provide search results. The search engine may actively search for data on the Internet, and mine for key information from the large amounts of data according to preset template information. The search engine may accordingly improve service quality and efficiency of the search engine, and thus meet user needs.

Web pages provide a content value-added service for users. The content value-added service may find a batch of files that have a high relevance to a search word, by cooperation with efficient retrieval mechanism of a search engine and related sorting. The content value-added service may elect web page data of specific sources from the files. Additionally or alternatively, the content value-added service may elect a web page set that has high quality and from which value-added content can be mined according to the quality of web page content itself. Additionally or alternatively, the content value-added service may generate, according to the template corresponding to the search word, structured information to provide value-added content for the user that submitted the search word. The user may, thus, be facilitated to make a decision according to the additional value-added content. For example, a user may subscribe to use a value-added content service for a certain search word in advance. When the user inputs the search word on a web page to perform a search, apart from performing normal retrievals on the search word, the search engine may start the value-added content service to provide additionally filtered information for the user if the user triggers an option for the value-added content service.

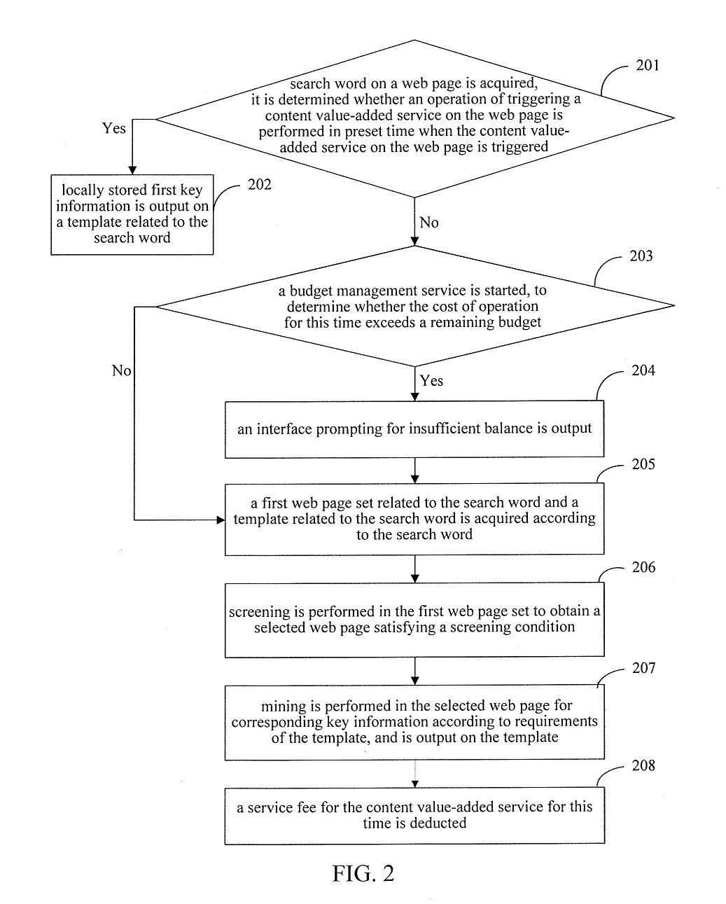

Referring to FIG. 2, a method may include at least the following steps.

In Step 201, the search engine may receive the search word via a web page. The search engine may determine whether the value-added content service has been triggered on the web page. The search engine may additionally determine if the service is triggered in preset time. If the value-added content service on the web page is triggered in the preset time, step 202 may be performed, else the process step 203 may be performed.

For example, the search word may be a name of a product purchased by a user such as an enterprise user, such as a certain mobile phone brand. Alternatively or in addition, the search word may be expressed by using natural language, which includes the name of the product purchased by the enterprise user, such as “how is the mobile phone of the certain brand.”

The web page may provide the value-added content service to the user, in case an option to provide the value-added content service is set ON for the web page. For example, the option of the value-added content service may be set under a functional menu, or the like.

In an example, when the user starts the value-added content service, the search engine may determine whether the value-added content service is being performed in a preset time. For example, it is determined whether the user started the service before and whether the time interval between the last operation time and this operation time is in the preset time. The preset time may be, for example, 1 day, 2 days, 10 days, 15 days, 30 days, or the like, or any other duration. If the value-added content service is performed in the preset time, and a server of the web page stores information acquired by the service for the last time, locally stored information may be directly output on the web page if the user starts the value-added content service again in the preset time.

In Step 202, locally stored first key information may be output on a template related to the search word.

For example, to improve service quality of the web page, multiple templates corresponding to the search word may be preset. The multiple templates may be setup according to classification of the search word and user context. For example, the users may be from various industries, such as a government department, a car industry, a film and television industry, or the like. According to different user context and search words, templates that may satisfy the different user demands may be preset. For example, in case that a search word is related to a car, titles such as car brand, look, evaluation, and suggestions are set on the template corresponding to the search word according to the user context, and corresponding information may be output under the respective titles of the template. In this step, if the value-added content service on the web page is triggered in the preset time, the locally stored first key information may be output using the template related to the search word. The first key information includes the information corresponding to the respective titles or fields in the template.

At this time, the value-added content service is completed once the locally stored first key information is output using the template related to the search word, and the following steps may not be performed.

In Step 203, a budget management service may be started to determine whether the cost of the requested search operation exceeds a remaining budget. If the cost of operation does exceed the remaining budget, step 204 may be performed, else the step 205 may be performed.

The value-added content service of the user may be a fee-based service. For example, after the user starts the content value-added service, the budget management service may be started to manage a pre-charge fee of the user. if the value-added content service is not triggered in the preset time. After the budget management service is started, an account balance for the user may be calculated. The search engine may determine whether the balance can afford the value-added content service operation at this time. In step 205, the value-added content service may be performed for the user if the balance can afford the operation, else step 204 may be performed.

If the value-added content service of the user is fee-based, in step 202, the service may not incur any charges for the search query if the value-added content service on the web page is performed in the preset time.

In Step 204, an interface prompting for insufficient balance may be output.

For example, when it is determined that the user's account balance cannot afford the value-added content service for the ongoing search request, an interface prompting for the insufficient balance may be output. In this case the value-added content service may be refused. The user may recharge to restore using the value-added content service. In an example, the value-added content service may be provided to the user even if the interface prompting for the insufficient balance is output. If the user does not recharge in time, the service may be refused the next time the user starts the value-added content service.

In Step 205, a first web page set related to the search word and a template related to the search word is identified corresponding to the search word.

For example, the server may include multiple search engines, that are classified in advance. Each search engine may be responsible for searching for a respective category. In another example, a search engine may search for several categories of search words. When the search words are acquired, the search words may be distributed to corresponding search engines according to classification of the search words. The search engines may perform retrievals in inverted indexes according to the search words, so as to obtain the first web page set from the Internet related to the search words.

In Step 206, the first web page set may be screened to obtain a selected web page satisfying a screening condition.

For example, this step may include screening the first web page set according to classification information of the search word and domain names of respective web pages in the first web page set to obtain a second web page set. Further, the first web page set may be screened after obtaining the first web page set related to the search word, to obtain more valuable data. For example, the classification information of the search word may include a government category, a car category, a film and television category, or the like. For example, sites corresponding to the classification information of each search word may be identified and screened according to the classification information of the search word and the domain names of the web pages. The search engine may further screen the second web page set according to information amounts of respective web pages in the second web page set. Web pages in the second web page set whose information amounts are less than a preset condition may be filtered out to obtain the selected web page related to the search word.

After the web pages are screened according to domain names of the web pages, the web pages in the second web page set may be screened according to the information amounts of the web pages. For example, the information amount of a web page may include length of content, feature of wording, or the like. When second screening is performed, web pages that lack sufficient information or are malicious may be filtered out according to length of content, feature of wording, or the like. For example, those web pages, in which evaluation does not provide detailed descriptions and suggestions but expresses opinions about products very briefly, may have little value for mining and may be filtered out during the second screening.

While the first web page set is acquired, a template corresponding to the search word may be identified from the preset multiple templates according to the search word.

In Step 207, the selected web page may be mined for corresponding key information according to requirements of the template, and the corresponding key information may be output on the template.

In this step, key words of the titles in the template may be acquired. Data mining may be performed on data in the selected web page according to the key words. For example, for search word of “mobile phone,” titles in a template related to the search word may include key words such as brand, look, evaluation, and suggestions, and information about the key words may be located in the selected web page. For example, when a search word is located in the web page, it is retrieved in a context of the search word that whether there is information about the key word. For example, whether there is information about the mobile phone brand, information about the mobile phone evaluation, or the like in an article. The key information about the key word may be acquired if there is the information about the mobile phone brand, the information about the mobile phone evaluation, or the like in the article.

Among a vast number, tens of billions, of web pages that are already crawled by the search engine, some may contain high quality, valuable information that the user may prefer to view. Web pages that have a reference value may evaluate a product and express opinions about the product. Evaluation may be focused on the product and making comments and suggestions on multiple characteristics of the product. For example, a certain mobile phone brand may have particular product properties such as display screen, size, battery life, thickness, call quality, and operating system. In such a web page, a context of the product may include emotional responses for the product, such as a like or dislike for the look of the mobile phone, and what advantages and disadvantages of the product are. When the data mining is performed, web pages that have quality information may be mined first, to determine results such as competition analysis, market analysis, public opinion probe, and risk management.

After the key information about the key words in the template is acquired, natural language processing may be performed on the corresponding key information to obtain text information such as a sentence that is clear and grammatically accurate. Key information corresponding to each key word may be inserted into a position under a title corresponding to the key word for output, to provide information about the content value-added service for the user.

After the corresponding key information is output on the template, the template corresponding to the search word and information on the template may be stored for a preset time. The locally stored information may be directly output to the user for reference when the user starts the value-added service again. In another example, information acquired by the service may not be stored.

In an example, the search word submitted by the user may change with continuous supplement of web page data in the Internet. In other words, a whole system for value-added service may automatically adapt, and users may see continuously updated evaluation results.

In Step 208, a service fee for the value-added content service for the search request may be deducted.

In this step, the service fee for this time may be deducted from the balance of the user after the value-added content service for the user is completed.

In an example, a prepayment method may be used to manage payment for the value-added content service. Alternatively or in addition, a post-payment method may be used to manage the fee-payments for the value-added content service. For example, to record the value-added content service used by the user and charge a corresponding fee to the user for the service after the user has used the service.

Thus, the search engine may provide a value-added content service without relying on external data. The search engine may actively searches for data on the Internet, and mine for key information from the web pages according to preset template information. The search engine may use the mined data to provide improved service quality and efficiency during search results.

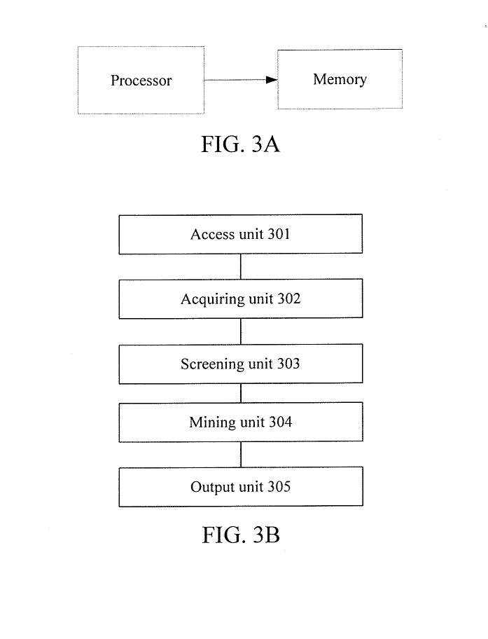

FIG. 3A and FIG. 3B, illustrate an example apparatus for acquiring information. The apparatus may include a processor, a memory; and a plurality of program units stored in the memory and to be executed by the processor, as shown in FIG. 3A. As shown in FIG. 3B, the plurality of program units may include, among others, an access unit 301, an acquiring unit 302, a screening unit 303, a mining unit 304, and an output unit 305.

The access unit 301 may acquire a search word on a web page. The acquiring unit 302 may acquire a first web page set related to the search word and a template related to the search word when a value-added content service is triggered on the web page. The screening unit 303 may screen the first web page set to obtain a selected web page that satisfies a screening condition. The mining unit 304 may mine the selected web page for key information corresponding to fields in the template. The output unit 305 may output the key information using the template.

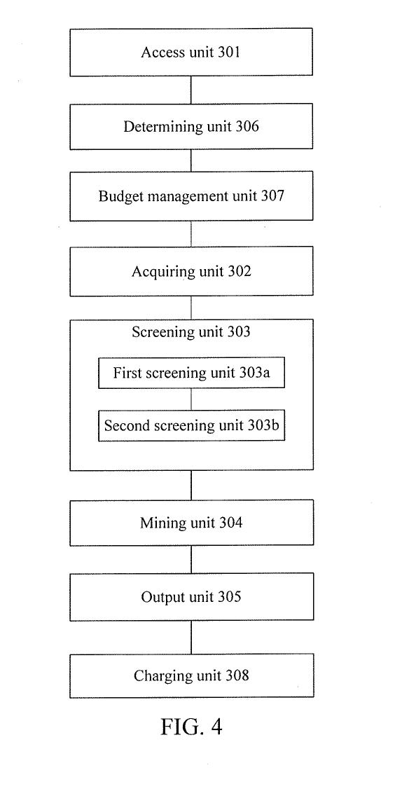

Referring to FIG. 4, the screening unit 303 may further include, among other units, a first screening unit 303a and a second screening unit 303b. The first screening unit 303a may screen the first web page set according to classification information of the search word and domain names of respective web pages in the first web page set to obtain a second web page set. The second screening unit 303b may screen the second web page set according to information amounts of respective web pages in the second web page set. The second screening unit 303b may filter out web pages in the second web page set whose information amounts are less than a preset condition to obtain the selected web page related to the search word and satisfying the screening conditions.

The mining unit 304 may acquire a key word corresponding to a field in the template, locate the search word from the user in the selected web page, and retrieve information about the key word in a context of the location of the search word to obtain the key information to be added to the template.

Referring to FIG. 4, the plurality of program units may further include a determining unit 306. The determining unit 306 may determine whether the value-added content service has been triggered on the web page in preset time. The determining unit 306 may make the determination before the acquiring unit 302 acquires the first web page set. The determining unit 306 may output locally stored first key information using the template related to the search word if the value-added content service was triggered on the web page in the preset time.

Referring to FIG. 4, the plurality of program units may further include a budget management unit 307. The budget management unit 307 may start a budget management service if the value-added content service on the web page is not triggered in the preset time. The budget management unit 307 may determine whether cost for the search operation exceeds a remaining budget in the user's account, and proceed to perform the search operation according to the search word if the cost for the operation does not exceed the remaining budget.

Referring to FIG. 4, the plurality of program units may include a charging unit 308 that may deduct a service fee for the value-added content service for the search operation after the output unit 305 outputs the corresponding key information using the template.

Thus, the search engine may provide search results in a predetermined template format, where the template may be formatted according to a context of the search being performed. Further, the search engine may not rely on any external data to provide the search results. The search engine may actively search for data on the Internet, and mine key information from data according to the preset template information, and improve service quality and efficiency of the search engine.

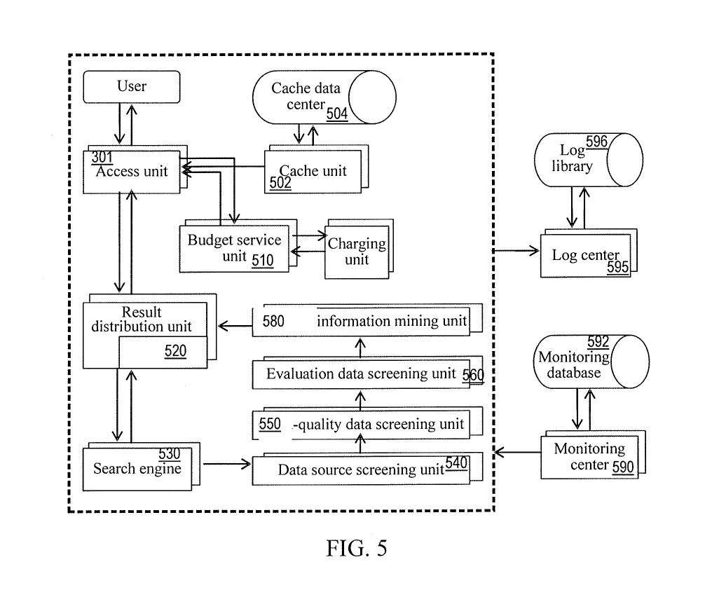

The above functional units are only described for exemplary purposes. In actual applications, the functions may be allocated to and implemented by different functional units as required, and the internal structure of the apparatus may be divided to different functional units to complete all or some of the above described functions. For example, as shown in FIG. 5, an example apparatus for acquiring product evaluation information may include, among other units, an access unit 301, a cache unit 502, a cache data center 504, a budget service unit 510, a result distribution unit 520, a search engine 530, a data source screening unit 540, a data screening unit 550, an evaluation data screening unit 560, and an information mining unit 580.

The access unit 301 may acquire a search word input by a user, access the cache unit, and directly return cached value-added content sought by the user. The access unit 301 may not assess a fee if the user has recently searched for a related search word in a specified time window. For example, if a time difference between the last search and the current search is within the preset time. Else, the access unit 301 may access the budget service unit 510 first to check if the user has a remaining budget to pay for the search result retrieval for the current search. The access unit 301 may start the value-added content service for the search results retrieval if the user has sufficient funds in the account to pay for the current search. Alternatively or in addition, the access unit 301 may notify the user to recharge the account for current search or a future search query.

The cache unit 502 may cache value-added content service results that use user names and search words as key words.

The cache data center 504 may store cache data and provide pre-cached data when a system is loaded.

The budget service unit 510 may start budget management for the user if the value-added content service is triggered when the user searches for the current search word. If the remaining budget is exceeded, the budget service unit may prompt the user that the user needs to recharge. Alternatively or in addition, the budget service unit 510 may proceed if the budget is not exceeded. The charging unit 308 may deduct the service fee for the current search, after the value-added content is successfully submitted to the user.

The result distribution unit 520 may pass the search word to the search engine 530 and obtain search results of the search engine. The result distribution unit 520 may select a template according to the search word, and access the data source screening unit based on a template identifier. The template may be a structured data framework designed according to user context. For example, context on car evaluation may be expressed by a multi-tuple set of <car brand, look, evaluation, and suggestions>. The template identifier may be a serial number corresponding to templates in a template library to identify respective templates.

The search engine 530 may obtain web pages related to the search word based on a search comprising an initial screening on relevance. The search engine 530 may use the web pages as a data set for further mining for the value-added content.

The data source screening unit 540 may screen web pages in accordance with domain names in related web pages of the search engine according to the classification information of the search word and a domain name list corresponding to the classification information. The classification information may be a category. For example, for car evaluation, web pages on a website such as “http://club.autohome.com.cn/” (autohome forum) may be screened. When a web page is screened, the web page is short listed as a potential search result to be displayed to the user.

The data screening unit 550 may further screen the web pages according to information amounts of the web pages. For example, web pages that lack sufficient information or are malicious may be filtered out. In an example, length of content or wording of the content on the web page may be evaluated to filter the web page. For example, in case the user requests a value-added content service for a search related to reviews of a product, those web pages, in which reviews do not provide proper descriptions and suggestions or express opinions about the products below a predetermined quality threshold, may be filtered out during the screening. Thus, the web pages with descriptions shorter than a predetermined limit or that do not qualify based on a predetermined quality threshold may not be shortlisted to display as search results to the user. The quality of the threshold may be determined based on natural language parsing of the web page and a qualitative analysis of the contents of the web page.

The evaluation data screening unit 560 may identify whether web page content provides reviews of products corresponding to the search word or are in context of the search word.

The information mining unit 580 may mine the web page data for corresponding information according to fields of the template. For example, the template may include fields, such as, an emotional tendency, a suggestions, or the like based on the category of the template. For example, a template for a car related search may include fields related to characteristics of a car so as to provide an evaluation of car information.

The apparatus may further include, a log center 595 and a monitoring center 590.

The log center 595 may collect logs generated by the system during execution of search queries, and store the logs in a log library 596. The log library may be a memory.

The monitoring center 590 may monitor the value-added service system during the execution, and store the reports regarding the conditions of the system in a monitoring database 592 according to time.

The example apparatus for acquiring information illustrated by FIG. 5 may be one example of distributing the operations of the apparatus. Other structural division of the operations may be possible. Further, the apparatus may implement the example methods described throughout the present document. Additionally, the components of the example apparatus described throughout the present document may be interchanged.

Thus, the search engine may provide search results in a predetermined template format, where the template may be formatted according to a context of the search being performed. Further, the search engine may not rely on any external data to provide the search results. The search engine may actively search for data on the Internet, and mine key information from data according to the preset template information, and improve service quality and efficiency of the search engine.

The example apparatus and methods described throughout the present document may be implemented using hardware. In an example, the examples may be implemented by a memory product containing instructions that are executed by hardware. The memory product may be a computer readable storage medium. The storage medium may store a specified program, or program instructions that are computer executable, such as by a processor. For example, the storage medium may include instructions to acquire a search word on a web page. The storage medium may further include instructions to acquire a first web page set corresponding to the search word. The storage medium may further include instructions to identify a template corresponding to the search word. The storage medium may further include instructions to identify the first web page set and the template when a value-added content service is triggered on the web page. For example, the user initiating the search request may trigger the value-added content service.

The storage medium may further include instructions to screen the first web page set to select a web page satisfying a screening condition. The storage medium may further include instructions to mine the selected web page to locate key information according to fields of the template identified for the current search. The storage medium may further include instructions to output the key information corresponding the template using the format predetermined by the identified template.

Screening the first web page set to select a web page satisfying a screening condition may include categorizing the web pages in the first web page set according to classification information corresponding to the search word and domain names of respective web pages in the first web page set. Based on the categorization, a second web page set, which is a subset of the first web page set may be obtained. The second web page set may be screened according to information amounts of respective web pages in the second web page set. Web pages in the second web page set that contain information amounts less than a preset condition may be filtered out to select the selected web page corresponding to the search word and satisfying the screening conditions.

The step of mining the selected web page for key information corresponding to the fields of the template may include acquiring a key word of a field in the template, locating the search word in the selected web page, and retrieving information about the key word in a context of the search word to obtain the key information. The context of the search word in the web page may be a proximity in the web page, such as in the same paragraph, same section, same sentence, and the like.

In an example, prior to initiating the value-added content service search, the method may include determining whether the content value-added service on the web page for a previous search was triggered in preset time. If the service was triggered in the preset time for a related search, locally stored first key information that resulted from the previous search may be output using the template.

In an example, a budget management service may be started if the content value-added service on the web page was not performed in the preset time for a previous search. The budget management service may determine whether cost for the search may exceed a balance in the user's account. If the cost for the search operation with the value-added content service does not exceed the account balance, the system may proceed with the search operation.

Once the key information is output according to the template, a service fee for the value-added content service for the current search may be deducted from the account balance, that is the user's account may be charged a fee for the service.

Thus, the search engine may provide a value-added content service without relying on external data. The search engine may actively searches for data on the Internet, and mine for key information from the web pages according to preset template information. The search engine may use the mined data to provide improved service quality and efficiency during search results.

An example method implemented by a computer, may include at least the following steps, among other as described throughout the present document.

1) Receiving a search word on a web page.

2) Determine that a value-added content service is triggered on the web page, such as by the user. Identifying a first web page set related to the search word. Identifying a template related to the search word.

3) Filtering the first web page set to obtain a selected web page satisfying a screening condition.

4) Analyzing the selected web page for to locate key information corresponding to fields of the template.

5) Outputting the corresponding key information on the template.

Filtering the first web page set to obtain the selected web page satisfying a screening condition includes may include categorizing the respective web pages in the first web page set according to classification information of the search word and domain names of the respective web pages. The web pages shortlisted from the first web page set may be included in a second web page set. The second web page set may be screened according to information amounts of respective web pages in the second web page set. The respective web pages in the second web page set with information amounts less than a preset condition may be eliminated to obtain the selected web page corresponding to the search word and satisfying the screening conditions.

Analyzing the selected web page to locate key information corresponding to fields of the template includes acquiring a key word of a field in the template. The search word may be located in the selected web page. Information about the key word may be identified in a context of the search word, such as in a proximity of the location of the search word in the selected web page. The key information may then be displayed using the predetermined fields of the template.

In an example, before acquiring the first web page set, the method may include determining whether the current search is being performed within a preset time from a previous search with related search words. In that case locally stored first key information from the previous search may be displayed using the template related to the search word. If a related search was not previously performed, the search may be initiated to provide the value-added content service.

In an example, a budget management service may be started if the current search is not being performed in the preset time. The budget management service may determine whether cost for the operation exceeds a balance in the user's account. If the user's account has sufficient funds to pay for the cost for the current search operation with the value-added content service the current search may be initiated.

In an example, once the results of the current search are output according to the predetermined fields in the template, the method further includes deducting a service fee as the cost of the current search with the value-added content service.

Thus, the search engine may provide a value-added content service without relying on external data. The search engine may actively searches for data on the Internet, and mine for key information from the web pages according to preset template information. The search engine may use the mined data to provide improved service quality and efficiency during search results.

An example apparatus may include a processor and a storage medium, where the storage medium stores a program instructions, and the processor may perform the following steps upon execution of the program instructions. The storage medium may be a non-transitory computer readable storage medium. The apparatus may acquire a search word on a web page. The apparatus may identify a first web page set related to the search word and identify a template related to the search word if a value-added content service is triggered on the web page. The apparatus may perform a screening on the first web page set to obtain a selected web page satisfying a screening condition. The apparatus may mine the selected web page to find key information according to fields of the template. The apparatus may output the key information according to the structure of the template.

The step of performing screening in the first web page set may include categorizing the respective web pages in the first web page set according to classification information of the search word and domain names of the respective web pages. The web pages shortlisted from the first web page set may be included in a second web page set. The second web page set may be screened according to information amounts of respective web pages in the second web page set. The respective web pages in the second web page set with information amounts less than a preset condition may be eliminated to obtain the selected web page corresponding to the search word and satisfying the screening conditions.

The step of mining the selected web page may include acquiring a key word of a field in the template. The search word may be located in the selected web page. Information about the key word may be identified in a context of the search word, such as in a proximity of the location of the search word in the selected web page. The key information may then be displayed using the predetermined fields of the template.

In an example, before acquiring the first web page set, the apparatus may determine whether the current search is being performed within a preset time from a previous search with related search words. In that case, the apparatus may output locally stored first key information from the previous search using the template related to the search word. If a related search was not previously performed, the apparatus may perform the search to provide the value-added content service.

In an example, a budget management service may be started if the current search is not being performed in the preset time. The apparatus, based on the budget management service, may determine whether cost for the operation exceeds a balance in the user's account. If the user's account has sufficient funds to pay for the cost for the current search operation with the value-added content service the apparatus may perform current search.

In an example, once the apparatus outputs the results of the current search according to the predetermined fields in the template, the apparatus may deduct a service fee as the cost of the current search with the value-added content service.

Thus, the apparatus provides a search engine with value-added content service. The search engine may provide the value-added content service without relying on external data. The search engine may actively searches for data on the Internet, and mine for key information from the web pages according to preset template information. The search engine may use the mined data to provide improved service quality and efficiency during search results.

Some features are shown stored in a computer readable storage medium (for example, as logic implemented as computer executable instructions or as data structures in memory). All or part of the system and its logic and data structures may be stored on, distributed across, or read from one or more types of computer readable storage media. Examples of the computer readable storage medium may include a hard disk, a floppy disk, a CD-ROM, a flash drive, a cache, volatile memory, non-volatile memory, RAM, flash memory, or any other type of computer readable storage medium or storage media. The computer readable storage medium may include any type of non-transitory computer readable medium, such as a CD-ROM, a volatile memory, a non-volatile memory, ROM, RAM, or any other suitable storage device. However, the computer readable storage medium is not a transitory transmission medium for propagating signals.

The processing capability of the components of the communication apparatus, such as the communication apparatus 100 and/or the communication apparatus 400, may be distributed among multiple entities, such as among multiple processors and memories, optionally including multiple distributed processing systems. Parameters, databases, and other data structures may be separately stored and managed, may be incorporated into a single memory or database, may be logically and physically organized in many different ways, and may implemented with different types of data structures such as linked lists, hash tables, or implicit storage mechanisms. Logic, such as programs or circuitry, may be combined or split among multiple programs, distributed across several memories and processors, and may be implemented in a library, such as a shared library (for example, a dynamic link library (DLL)). The DLL, for example, may store code that prepares intermediate mappings or implements a search on the mappings. As another example, the DLL may itself provide all or some of the functionality of the system, tool, or both.

All of the discussion, regardless of the particular implementation described, is exemplary in nature, rather than limiting. For example, although selected aspects, features, or components of the implementations are depicted as being stored in memories, all or part of the system or systems may be stored on, distributed across, or read from other computer readable storage media, for example, secondary storage devices such as hard disks, flash memory drives, floppy disks, and CD-ROMs. Moreover, the various components and screen display functionality is but one example of such functionality and any other configurations encompassing similar functionality are possible.

The respective logic, software or instructions for implementing the processes, methods and/or techniques discussed above may be provided on computer readable storage media. The functions, acts or tasks illustrated in the figures or described herein may be executed in response to one or more sets of logic or instructions stored in or on computer readable media. The functions, acts or tasks are independent of the particular type of instructions set, storage media, processor or processing strategy and may be performed by software, hardware, integrated circuits, firmware, micro code and the like, operating alone or in combination. Likewise, processing strategies may include multiprocessing, multitasking, parallel processing and the like. In one embodiment, the instructions are stored on a removable media device for reading by local or remote systems. In other embodiments, the logic or instructions are stored in a remote location for transfer through a computer network or over telephone lines. In yet other embodiments, the logic or instructions are stored within a given computer, central processing unit (“CPU”), graphics processing unit (“GPU”), or system.

Furthermore, although specific components are described above, methods, systems, and articles of manufacture described herein may include additional, fewer, or different components. For example, a processor may be implemented as a microprocessor, microcontroller, application specific integrated circuit (ASIC), discrete logic, or a combination of other type of circuits or logic. Similarly, memories may be DRAM, SRAM, Flash or any other type of memory. Flags, data, databases, tables, entities, and other data structures may be separately stored and managed, may be incorporated into a single memory or database, may be distributed, or may be logically and physically organized in many different ways. The components may operate independently or be part of a same program or apparatus. The components may be resident on separate hardware, such as separate removable circuit boards, or share common hardware, such as a same memory and processor for implementing instructions from the memory. Programs may be parts of a single program, separate programs, or distributed across several memories and processors.

A second action may be said to be “in response to” a first action independent of whether the second action results directly or indirectly from the first action. The second action may occur at a substantially later time than the first action and still be in response to the first action. Similarly, the second action may be said to be in response to the first action even if intervening actions take place between the first action and the second action, and even if one or more of the intervening actions directly cause the second action to be performed. For example, a second action may be in response to a first action if the first action sets a flag and a third action later initiates the second action whenever the flag is set.

To clarify the use of and to hereby provide notice to the public, the phrases “at least one of <A>, <B>, . . . and <N>” or “at least one of <A>, <B>, . . . <N>, or combinations thereof” or “<A>, <B>, . . . and/or <N>” are to be construed in the broadest sense, superseding any other implied definitions hereinbefore or hereinafter unless expressly asserted to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed.

While various embodiments have been described, it will be apparent to those of ordinary skill in the art that many more embodiments and implementations are possible. Accordingly, the embodiments described herein are examples, not the only possible embodiments and implementations.

What is claimed is:

1. A method for acquiring information, comprising:
receiving a search word via a web page;
identifying a first web page set corresponding to the search word in response to a value-added service on the web page being triggered;
screening the first web page set to select a selected web page that satisfies a screening condition;
mining the selected web page for key information according to fields of a template corresponding to the search word; and
outputting the key information.

2. The method according to claim 1, wherein the step of screening the first web page set to select the selected web page that satisfies the screening condition comprises:
classifying the first web page set according to classification information of the search word and domain names of respective web pages in the first web page set to identify a second web page set; and
screening the second web page set based on information amounts contained by respective web pages in the second web page set, and filtering out web pages from the second web page set that contain information amounts less than a preset condition.

3. The method according to claim 1, wherein the step of mining the selected web page for corresponding key information according to the template comprises:
acquiring a key word of a title in the template,
locating the search word in the selected web page, and
retrieving information about the key word in proximity of the search word to obtain the key information.

4. The method according to claim 1, wherein before identifying the first web page set corresponding to the search word, the method further comprises:
outputting locally stored first key information in the template corresponding to the search word in response to the value-added service on the web page being triggered within a preset time from a previous operation of the value-added service on the web page.

5. The method according to claim 4, further comprising:
starting a budget management service in response to the value-added service on the web page not being triggered in the preset time, and
identifying the first web page set corresponding to the search word in response to a cost for the value-added service exceeding a remaining budget.

6. The method according to claim 5, wherein after outputting the key information, the method further comprises:
deducting a service fee for the value-added service.

7. An apparatus for acquiring information, comprising:
one or more processors;
memory; and
a plurality of program units stored in the memory and to be executed by the one or more processors, the plurality of program units comprising:
an access unit configured to acquire a search word on a web page;
an acquiring unit configured to acquire a first web page set corresponding to the search word and a template corresponding to the search word in response to a value-added content service on the web page being triggered;
a screening unit configured to select a selected web page from the first web page set;
a mining unit configured to mine the selected web page for key information corresponding to the template; and
an output unit configured to output the key information using predetermined fields of the template.

8. The apparatus according to claim 7, wherein the screening unit comprises:
a first screening unit configured to screen the first web page set according to classification information of the search word and domain names of respective web pages in the first web page set to identify a second web page set; and
a second screening unit configured to screen the second web page set according to information amounts of respective web pages in the second web page set, and filter out web pages in the second web page set with information amounts less than a preset condition to select the selected web page corresponding to the search word and satisfying screening conditions.

9. The apparatus according to claim 7, wherein the mining unit is further configured to:
acquire a key word of a title in the template,
locate the search word in the selected web page, and
retrieve information about the key word in a context of the search word to obtain the key information.

10. The apparatus according to claim 7, wherein the plurality of program units further comprise:
a determining unit configured to:
determine output locally stored first key information on the template related to the search word if the content value-added service on the web page is triggered in a preset time since a previous search.

11. The apparatus according to claim 10, wherein the plurality of program units further comprise:
a budget management unit configured to:
start a budget management service in response to the content value-added service on the web page not being performed in the preset time, and determine that a cost for the value-added content service is within a remaining budget, wherein the first web page set corresponding to the search word and the template related to the search word according to the search word if the cost for the value-added content service is within the remaining budget.

12. The apparatus according to claim 11, wherein the plurality of program units further comprise: a charging unit configured to deduct a service fee for the content value-added service after the output unit outputs the key information on the template.

13. A computer readable storage medium storing computer executable instructions, the computer readable storage medium comprising:
instructions to acquire a search word on a web page;
instructions to identify a first web page set corresponding to the search word and identify a template related to the search word in response to a value-added service on the web page being triggered;
instructions to select a selected web page based on a screening condition;
instructions to identify, in the selected web page, key information corresponding to fields of the template; and
outputting the key information according to the fields of the template.
